(19) United States
(12) Patent Application Publication
(10) Pub. No.: US 2008/0174277 A1
(43) Pub. Date: Jul. 24, 2008

(54) CHARGING APPARATUS

(75) Inventor: Tomotaka UENO, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/956,017

(22) Filed: Dec. 13, 2007

(30) Foreign Application Priority Data
Jan. 24, 2007 (JP) 2007-014312

(51) Int. Cl. H02J 7/04; H02J 7/00

(52) U.S. Cl. 320/138

(57) ABSTRACT

There is provided a charging apparatus that enables safe and stable charging operation upon switching of power supplies for charging use. The charging apparatus has: first power supply 111 that has a current limiting function; second power supply 112 that has a current limiting function lower than the current limiting function of first power supply 111; first charging circuit 120 that charges battery 101 using first power supply 111; second charging circuit 130 that charges battery 101 using second power supply 112; and power supply selecting circuit 140 that detects the voltage of the first power supply and the voltage of the second power supply and controls charging operation of the second charging circuit based on the detected results. The charging apparatus selects one of first charging circuit 120 and second charging circuit 130 based on the output voltage of first power supply 111 that has a current limiting function, and controls the charging current upon charging operation from second power supply 112 that has a lower current limiting function.

### CROSS REFERENCE TO RELATED APPLICATIONS

The disclosure of Japanese Patent Application No. 2007-014312, filed on Jan. 24, 2007, including the specification, drawings and abstract, is incorporated herein by reference in its entirety.

### BACKGROUND OF THE INVENTION

1. Field of the Invention

The present invention relates to a charging apparatus provided with a plurality of power supplies including a power supply from a USB (Universal Serial Bus) interface (hereinafter “USB power supply”).

2. Description of Related Art

The USB attracts attention as an interface standard for connecting personal computers with peripherals. The USB adopts a scheme of transmitting serial data using two signal lines.

In recent years, charging apparatuses used in electronic devices such as mobile devices having batteries include a charging apparatus that charges a battery from a plurality of power supplies including a USB power supply in addition to a power supply such as an AC adapter.

As such a conventional charging apparatus, for example, Patent Document 1 (Japanese Patent Application Laid-Open No. 2001-202163) discloses a portable electronic device.

FIG. 1 is a block diagram showing a configuration of the charging apparatus disclosed in Patent Document 1.

In FIG. 1, charging apparatus 10 is configured with battery 11, USB power supply 12, charging power supply 13 and USB charging control circuit 14.

USB charging control circuit 14 charges battery 11 based on the power supply supplied from USB power supply 12. Generally, external charging power supply 13 which is optimized for batteries of portable electronic devices, can perform charging efficiently. For example, external charging power supply 13 can perform charging in a short period of time. Therefore, when charging power supply 13, which is a main power supply for charging, is connected, battery 11 is not charged from USB power supply 12 but is charged from charging power supply 13.

As described above, by adopting a configuration where battery 11 can be charged from a plurality of power supplies including external charging power supply 13 such as an AC adapter and USB power supply 12, usability of the electronic devices are improved.

However, with such a conventional charging apparatus, in a state where a charging power supply having a current limiting function, and a USB power supply having a lower current limiting function than the charging power supply, are connected as power supplies for charging use, when the charging power supply that is being used for charging is disconnected and charging is switched to the USB power supply, there is a problem that excessive current flows, which leads to damage or performance deterioration of the USB power supply.

### SUMMARY OF THE INVENTION

It is therefore an object of the present invention to provide a charging apparatus that enables safe and stable charging operation upon switching of power supplies for charging use.

According to an aspect of the invention, the charging apparatus has: a battery; a first power supply that has a current limiting function; a second power supply that has a lower current limiting function than the first power supply; a first charging circuit that charges the battery using the second power supply; a second charging circuit that charges the battery using the second power supply; and a control circuit that detects the voltage of the first power supply and the voltage of the second power supply and controls charging operation of the second charging circuit based on the detected results.

### BRIEF DESCRIPTION OF THE DRAWINGS

FIG. 1 is a block diagram showing a configuration of a conventional charging apparatus;

FIG. 2 is a circuit diagram showing a configuration of a charging apparatus according to Embodiment 1 of the present invention;

FIG. 3 is a circuit diagram showing a configuration of a control circuit of a power supply selecting circuit of the charging apparatus according to Embodiment 1;

FIG. 4 is an operation waveform diagram of the charging apparatus according to Embodiment 1; and

FIG. 5 is a circuit diagram showing a configuration of a control circuit of a power supply selecting circuit of the charging apparatus according to Embodiment 2 of the present invention.

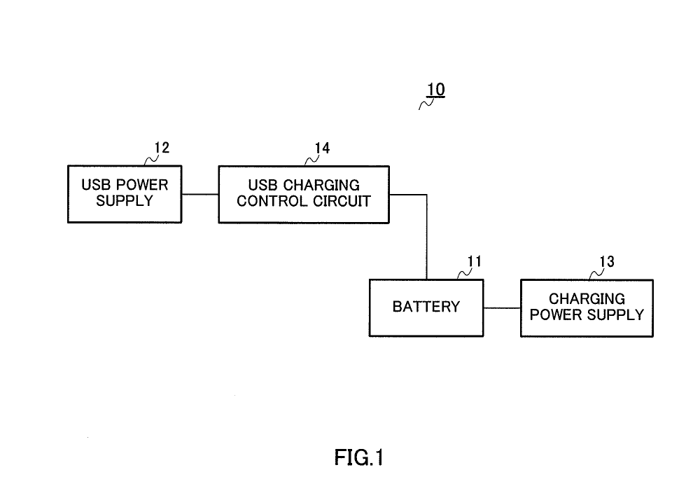

### DETAILED DESCRIPTION OF THE PREFERRED EMBODIMENT

Embodiments of the present invention will be described in detail below with reference to the accompanying drawings.

### Embodiment 1

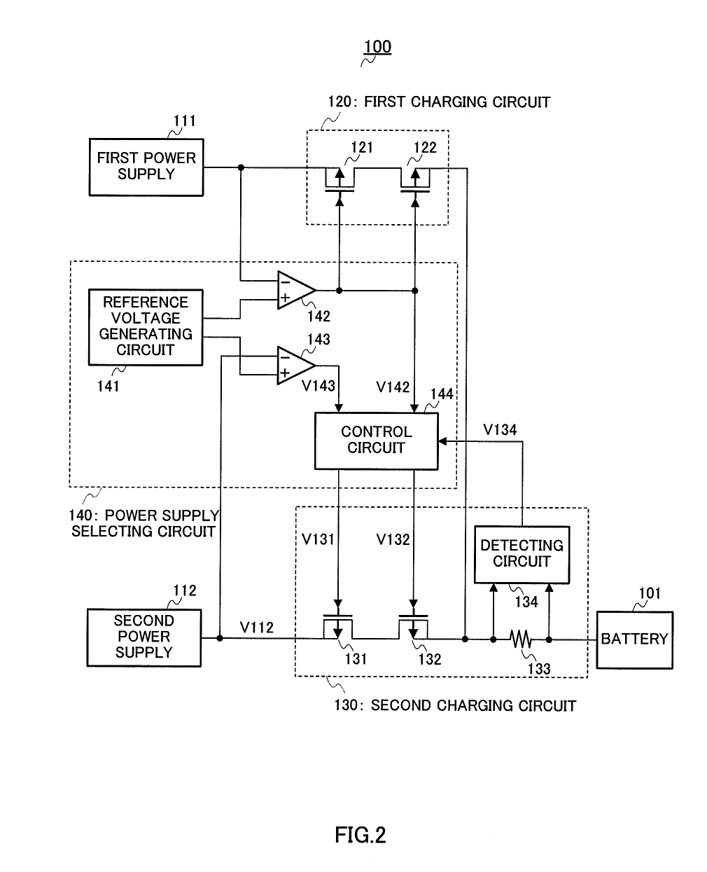

FIG. 2 is a circuit diagram showing a configuration of the charging apparatus according to Embodiment 1 of the present invention. This embodiment is an example where the present invention is applied to a charging apparatus having a plurality of power supplies including a USB power supply.

In FIG. 2, charging apparatus 100 is configured with: battery 101; first power supply 111 that has a current limiting function; second power supply 112 that has a lower current limiting function than first power supply 112; first charging circuit 120 that charges battery 101 using first power supply 111; second charging circuit 130 that charges battery 101 using second power supply 112; and power supply selecting circuit 140 that detects the voltage of the first power supply and the voltage of the second power supply and controls the charging operation of the second charging circuit based on detected results.

Battery 101 is a secondary battery which is a charging target in this charging apparatus 100. First power supply 111 is an external charging power supply such as an AC adapter, and has a current limiting function of decreasing supply voltage when a current equal to or greater than a predetermined value is supplied. Second power supply 112 is a power supply such as a USB power supply, and has a lower current limiting function than first power supply 111.

First charging circuit 120 has switch element 121 for controlling charging and switch element 122 for preventing counter current, which are comprised of transistors, and charges battery 101 using first power supply 111. Second charging circuit 130 has control element 131 for controlling charging which is comprised of PMOS transistors, switch element 132 for preventing counter current which is comprised of PMOS transistors, detecting resistance 133 for detecting current and detecting circuit 134 that detects charging current from second power supply 112, and second charging circuit 130 charges battery 101 using second power supply 112.

Power supply selecting circuit 140 has: comparator 142 that compares the output voltage of first power supply 111 with the output voltage of reference voltage generating circuit 141; comparator 143 that compares the output voltage of second power supply 112 with the output voltage of reference voltage generating circuit 141; control circuit 144 that controls second charging circuit 130 based on the output results of comparator 142 and comparator 143 and the output result of detecting circuit 134. When the output voltage of first power supply 111 falls below a predetermined value, control circuit 144 stops first charging circuit 120 and controls the operation of second charging circuit 130.

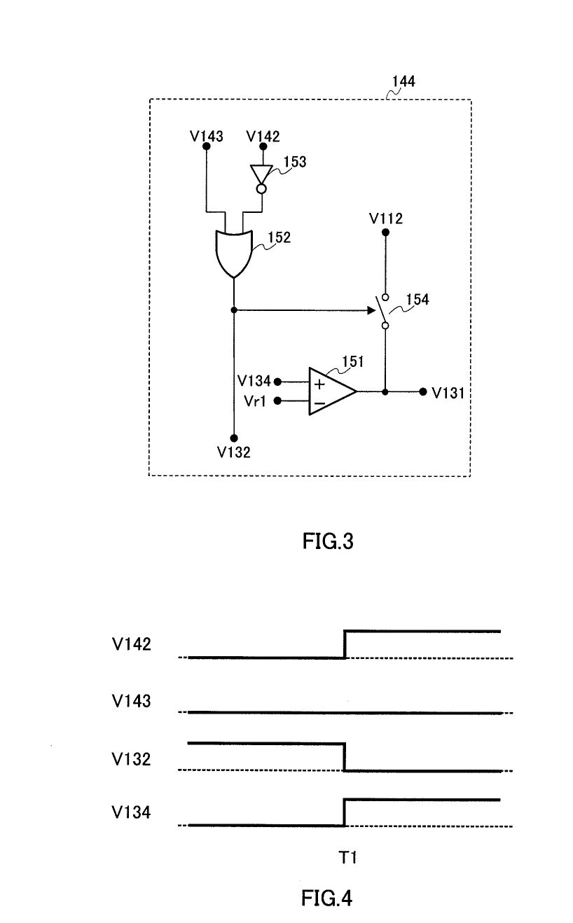

FIG. 3 is a circuit diagram showing a configuration of control circuit 144 of above-described power supply selecting circuit 140.

In FIG. 3, control circuit 144 is configured with charging control circuit 151, OR circuit 152, inverter 153 and switch element 154.

Charging control circuit 151 controls the charging current to predetermined values by adjusting signal V131 that drives control element 131 so that detected voltage V134 outputted from detecting circuit 134 is equal to reference voltage Vr1.

Inverter 153 logically inverts output V142 of comparator 142. OR circuit 152 calculates the logical sum of the inverted signal of output V142 of comparator 142 and output V143 of comparator 143 and outputs the logical sum as signal V132 that drives switch element 132 of second charging circuit 130. Switch element 154 is connected between the output of second power supply 112 and the output of control circuit 144, and is closed when signal V132 is inputted at a high level, and is opened when signal V132 is inputted at a low level.

The operation of charging apparatus 100 configured as described above will be described below.

### [The Basic Operation of Control Circuit 144 of Power Supply Selecting Circuit 140]

FIG. 4 is an operation waveform diagram of charging apparatus 100.

Charging control circuit 151 of control circuit 144 controls the charging current to a predetermined value by adjusting signal V131 that drives control element 131 so that detected voltage V134 outputted from detecting circuit 134 is equal to reference voltage Vr1. Output V142 of comparator 142 is logically inverted by inverter 153 and inputted to OR circuit 152 with output V143 of comparator 143. The output of OR circuit 152 is outputted as signal V132 that drives switch element 132 of second charging circuit 130. Switch element 154 is connected between the output of second power supply 112 and the output of control circuit 144, and is closed when signal V132 is inputted at a high level, and is opened when signal V132 is inputted at a low level.

### [The Operation of Control Circuit 144 of Power Supply Selecting Circuit 140]

First, in the period in the operation waveform diagram in FIG. 4 up to time T1, when the output voltage of first power supply 111 is higher than the output voltage of reference voltage generating circuit 141, output V142 of comparator 142 becomes a low level, and switch element 121 and switch element 122 in first charging circuit 120 are closed. On the other hand, when the output voltage of second power supply 112 is higher than the output of reference voltage generating circuit 141, output V143 of comparator 143 becomes a low level, signal V132 becomes a high level as a result of logical operation with output V142 of comparator 142, switch element 132 is opened, and second charging circuit 130 is opened. Further, signal V132 is a high level, and so switch element 154 is closed, the output voltage of signal V131 is pulled up to the output voltage of second power supply 112, and, consequently, control element 131 is also opened.

Next, in time T1 in the operation waveform diagram in FIG. 4, when the output of first power supply decreases and output V142 of comparator 142 becomes a high level, switch element 121 and switch element 122 are opened, and first charging circuit 120 is stopped. On the other hand, output signal V132 of OR circuit 152 becomes a low level, and so switch element 131 in second charging circuit 130 is closed. Further, switch element 154 is opened, control circuit 144 controls control element 131 by signal V131 and controls the charging current to a predetermined value.

As described above, according to this embodiment, charging apparatus 100 employs a configuration having: first power supply 111 that has a current limiting function; second power supply 112 that has a lower current limiting function than first power supply 111; first charging circuit 120 that charges battery 101 using first power supply 111; second charging circuit 130 that charges battery 101 using second power supply 112; and power supply selecting circuit 140 that detects the voltage of the first power supply and the voltage of the second power supply and controls charging operation of the second charging circuit based on the detected results, and, in this configuration, one of first charging circuit 120 and second charging circuit 130 is selected according to the output voltage of first power supply 111 having the current limiting function, and the charging current is always controlled when the charging operation is performed using second power supply 112 having the lower current limiting function, so that it is possible to prevent excessive current supply and realize safe and stable charging control.

### Embodiment 2

Embodiment 1 has described a method of controlling charging using logical circuits provided in a control circuit. Embodiment 2 will describe a method of controlling charging using an external controlling means provided outside the control circuit.

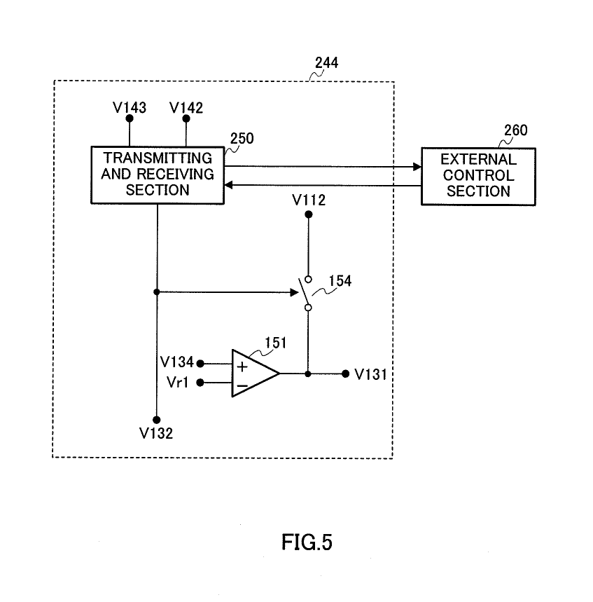

FIG. 5 is a circuit diagram showing a configuration of a control circuit of a power supply selecting circuit of the charging apparatus according to Embodiment 2 of the present invention. In this embodiment, the same components as those in FIG. 3 will be assigned the same reference numerals without further explanations. The configurations other than the configuration of the control circuit of the power supply selecting circuit of the charging apparatus, are the same as in FIG. 2, and this control circuit is used by replacing control circuit 144 in FIG. 2.

In FIG. 5, control circuit 244 of the power supply selecting circuit of the charging apparatus is configured with charging control circuit 151, transmitting and receiving section 250 that transmits and receives signals to and from external control section 260, and switch element 154.

Transmitting and receiving section 250 has a transmitting and receiving means such as a serial/parallel interface and transmits signals to the outside of control circuit 144 based on output V142 of comparator 142 and output V143 of comparator 143. Further, transmitting and receiving section 250 receives an input signal from external control section 260 and drives switch element 132 for preventing counter current and switch element 154 based on the received result.

External control section 260 has a storage means such as a micro processor and transmits signals read from the storage means to transmitting and receiving section 250 based on the signals transmitted from transmitting and receiving section 250. External control section 260 controls this charging apparatus. Further, external control section 260 may be a control means included in a mobile device and control this charging apparatus based on the state of the mobile device.

In this way, according to this embodiment, as with Embodiment 1, upon charging operation from a second power supply having the lower current limiting function, by controlling the charging current, it is possible to prevent excessive current supply and enable safe and stable charging control. Further, control is performed by external control section 260, so that it is possible to realize charging control with a higher level of usability.

Examples of preferred embodiments of the present invention have been described above, and yet the scope of the present invention is by no means limited to the above-described embodiments. For example, although PMOS transistors are used as switch element 122 and switch element 132 for preventing counter current in the above-described embodiments, diodes are also applicable.

Further, the above-described embodiments are examples where the present invention is applied to charging apparatuses for USB devices, but the present invention can be applied to any charging apparatus, if the charging apparatus has a second power supply having a lower current limiting function than a first power supply.

Furthermore, in the above-described embodiments, “charging apparatus” is used for convenience of explanation, but the charging apparatus may also be referred to as “charging control circuit,” “charger,” “power supply apparatus,” and so on.

Further, the type, number and connection method of circuit sections configuring the above-described charging apparatus, such as comparators and gate circuits, are not limited to the above-described embodiments.

As described above, according to the present invention, it is possible to control charging safely and stably upon switching of power supplies for charging use.

Therefore, the charging apparatus according to the present invention is suitable for use in electronic devices that charge mounted batteries from a plurality of power supplies including a power supply having a lower supply current limiting function.

What is claimed is:

1. A charging apparatus comprising:
a battery;
a first power supply that has a current limiting function;
a second power supply that has a lower current limiting function than the first power supply;
a first charging circuit that charges the battery using the first power supply;
a second charging circuit that charges the battery using the second power supply; and
a control circuit that detects a voltage of the first power supply and a voltage of the second power supply and controls charging operation of the second charging circuit based on the detected results.

2. The charging apparatus according to claim 1, wherein when the output voltage of the first power supply falls below a predetermined value, the control circuit stops the first charging circuit and controls the charging operation of the second charging circuit.

3. The charging apparatus according to claim 1, wherein the control circuit selects one of the first charging circuit and the second charging circuit based on the output voltage of the first power supply, and controls charging current from the second power supply upon charging operation from the second power supply.

4. The charging apparatus according to claim 1, further comprising an external control section,
wherein the control circuit comprises a transmitting and receiving section that transmits and receives data to and from the external control section.

5. The charging apparatus according to claim 4, wherein the control circuit controls the charging operation of the second charging circuit based on the received data from the external control section.

6. The charging apparatus according to claim 1, wherein the first power supply comprises an alternating current adapter, and the second power supply comprises a universal serial bus power supply.
